(19) United States
(12) Patent Application Publication
(10) Pub. No.: US 2003/0171245 A1
(43) Pub. Date: Sep. 11, 2003

(54) Surfactant agglomerates

(75) Inventors: Lucas Goovaerts, Haacht (BE); Eric Tcheou, Brussels (BE); Jose Luis Vega, Strombeek-Bever (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/303,388

(22) Filed: Nov. 25, 2002

Related U.S. Application Data
(63) Continuation of application No. 09/720,402, filed on Dec. 20, 2000, now abandoned.
Application No. 09/720,402 is a 371 of international application No. PCT/US99/15667, filed on Jul. 12, 1999.

(30) Foreign Application Priority Data
Jul. 10, 1998 (EP) 98870153.8
Apr. 30, 1999 (EP) 99870092.6

(51) Int. Cl. C11D 17/00

(52) U.S. Cl. 510/444

(57) ABSTRACT

A surfactant agglomerate is disclosed which has a reduced tendency to gel upon contact with water, and has an improved dissolution profile in water. The surfactant agglomerate comprises a water-soluble salt of acetate in close proximity with the surfactant.

### CROSS REFERENCE TO RELATED APPLICATION

This application is a continuation of U.S. Ser. No. 09/720,402, filed Dec. 20, 2000, which is incorporated by reference herein, which is a 371 of International Application No. PCT/US99/15667, filed Jul. 12, 1999.

### TECHNICAL FIELD

The present invention relates to surfactant agglomerates which are suitable for the formulation of detergent products. The agglomerates of the present invention have a reduced tendency to gel upon contact with water, and an improved dissolution profile.

### BACKGROUND OF THE INVENTION

Surfactants are important components of detergent compositions. Surfactant raw materials are generally available as liquids. When formulated in solid detergent compositions, they are typically sprayed onto a solid component of the composition, or provided to the composition in the form of an agglomerate. Agglomerates are obtained by agglomerating a liquid or pasty surfactant with a powdery carrier. Agglomerates have the advantage that they allow the formulation of compositions which are very active, in that they comprise a higher amount of surfactant by weight of the total composition. Surfactant agglomerates are known in the art.

A problem encountered with surfactant agglomerates upon use is that they tend to gel upon contact with water and they may have poor dissolution profiles. These two problems tend to increase as the activity of the agglomerate increases, and are particularly acute with nonionic surfactants. It is thus an object of the present invention to provide surfactant agglomerates with a reduced tendency to gel upon contact with water, and an improved dissolution profile in water.

It has now been found that this object could be met by formulating a surfactant agglomerate which comprises a surfactant and a carrier, and which further comprises a water-soluble salt of acetate in close proximity with the surfactant. Close proximity is preferably obtained by mixing the acetate with the surfactant or the carrier before they are agglomerated together, or by spraying the acetate, or a portion thereof, onto a pre-agglomerate of the surfactant and the carrier and, optionally the other portion of the acetate.

### SUMMARY OF THE INVENTION

The present invention encompasses a surfactant agglomerate comprising a surfactant and a carrier, and which further comprises a water-soluble salt of acetate in close proximity with the surfactant. The present invention further encompasses a detergent composition in granular or tablet form which comprises the agglomerate. The invention further encompasses processes for making the agglomerate. Finally, the invention encompasses a powdery mixture comprising a water-soluble salt of acetate which is suitable for making the agglomerate.

### DETAILED DESCRIPTION OF THE INVENTION

The Agglomerate:

The agglomerate of the present invention comprises at least three ingredients, which are the surfactant, a carrier, and the water-soluble salt of acetate.

The agglomerate of the present invention can be made with any surfactant but preferred surfactants for use herein are nonionic surfactants.

Suitable nonionic surfactants include compounds produced by the condensation of alkylene oxide groups (hydrophilic in nature) with an organic hydrophobic compound, which may be aliphatic or alkyl aromatic in nature. The length of the polyoxyalkylene group which is condensed with any particular hydrophobic group can be readily adjusted to yield a water-soluble compound having the desired degree of balance between hydrophilic and hydrophobic elements.

Particularly preferred for use in the present invention are nonionic surfactants such as the polyethylene oxide condensates of alkyl phenols, e.g., the condensation products of alkyl phenols having an alkyl group containing from about 6 to 16 carbon atoms, in either a straight chain or branched chain configuration, with from about 4 to 25 moles of ethylene oxide per mole of alkyl phenol.

Preferred nonionics are the water-soluble condensation products of aliphatic alcohols containing from 8 to 22 carbon atoms, in either straight chain or branched configuration, with an average of up to 25 moles of ethylene oxide per more of alcohol. Particularly preferred are the condensation products of alcohols having an alkyl group containing from about 9 to 15 carbon atoms with from about 2 to 10 moles of ethylene oxide per mole of alcohol; and condensation products of propylene glycol with ethylene oxide. Most preferred are condensation products of alcohols having an alkyl group containing from about 12 to 15 carbon atoms with an average of about 3 moles of ethylene oxide per mole of alcohol.

Another class of suitable nonionic surfactant is the class of polyhydroxy fatty acid amides which may be produced by reacting a fatty acid ester and an N-alkyl polyhydroxy amine. The preferred amine for use in the present invention is N—(R1)-CH2(CH2OH)4-CH2-OH, where R1 is typically a alkyl, e.g. methyl group; and the preferred ester is a C12-C20 fatty acid methyl ester.

Methods of manufacturing polyhydroxy fatty acid amides have been described in WO 92 6073, published on Apr. 16, 1992. This application describes the preparation of polyhydroxy fatty acid amides in the presence of solvents. In a highly preferred embodiment of the invention N-methyl glucamine is reacted with a C12-C20 methyl ester. It also says that the formulator of granular detergent compositions may find it convenient to run the amidation reaction in the presence of solvents which comprise alkoxylated, especially ethoxylated (EO 3-8) C12-C14 alcohols (page 15, lines 22-27). This can directly yield nonionic surfactant systems which are preferred in the present invention, such as those comprising N-methyl glucosamide and C12-C14 alcohols with an average of 3 ethoxylate groups per molecule.

Other nonionic surfactants which may be used as components of the surfactant systems herein include, glycerol ethers, glucosamides, glycerol amides, glycerol esters, fatty acids, fatty acid esters, fatty amides, alkyl polyglucosides, alkyl polyglycol ethers, polyethylene glycols, ethoxylated alkyl phenols and mixtures thereof.

While the present invention is preferably executed with nonionic surfactants, preferably ethoxylated alcohols, or mixtures of nonionic surfactants, it can also be executed with the other following surfactants which are anionic or others.

Suitable anionic surfactants for use herein include:

Alkyl Ester sulfonate surfactants hereof include linear esters of C₈-C₂₀ carboxylic acids (i.e. fatty acids) which are sulfonated with gaseous SO₃ according to “The Journal of the American Oil Chemists Society” 52 (1975), pp. 323-329. Suitable starting materials would include natural fatty substances as derived from tallow, palm oil, etc.

The preferred alkyl ester sulfonate surfactant, especially for laundry applications, comprises alkyl ester sulfonate surfactants of the structural formula:

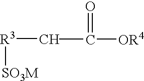

wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆alkyl, and R⁴ is methyl, ethyl or isopropyl. Especially preferred are the methyl ester sulfonates wherein R³ is C₁₄-C₁₆ alkyl.

Alkyl sulfate surfactants hereof are water soluble salts or acids or the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quarternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Alkyl alkoxylated sulfate surfactants hereof are water soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl ether (1.0) sulfate, C₁₂-C₁₈ alkyl ether (2.25) sulfate, C₁₂-C₁₈ alkyl ether (3.0) sulfate, and C12-C18 alkyl ether (4.0) sulfate, wherein the counterion is conveniently selected from sodium and potassium.

Other anionic surfactants useful for detersive purposes can also be included in the laundry detergent compositions of the present invention. These can include salts (including, for example, sodium, potassium, ammonium, and substituted ammonium salts such as mono-, di- and triethanolamine salts) of soap, C₉-C₂₀ linear alkylbenzenesulphonates, C₈-C₂₂ primary or secondary alkanesulphonates, C₈-C₂₄ olefinsulphonates, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to 10 moles of ethylene oxide); methyl ester sulphonates (MES); acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside, branched primary alkyl sulfates, alkyl polyethoxy carboxylates such as those of the formula RO(CH₂CH₂O)ₖCH₂COO—M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

The agglomerates of the present invention may also contain cationic, ampholytic, zwitterionic, and semi-polar surfactants.

Cationic detersive surfactants suitable for use in the laundry detergent compositions of the present invention are those having one long-chain hydrocarbyl group. Examples of such cationic surfactants include the ammonium surfactants such as alkyldimethylammonium halogenides, and those surfactants having the formula:

[R²(OR³)y][R⁴(OR³)y]₂R⁵N+X−

wherein R2 is an alkyl or alkyl benzyl group having from about 8 to about 18 carbon atoms in the alkyl chain, each R³ is selected from the group consisting of —CH₂CH₂—,

—CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups,

—CH₂COH—CHOHCOR⁶CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion. Other cationic surfactants useful herein are also described in U.S. Pat. No. 4,228,044, Cambre, issued Oct. 14, 1980, incorporated herein by reference.

Ampholytic surfactants are also suitable for use in the agglomerates of the present invention. These surfactants can be broadly described as aliphatic derivatives of secondary or tertiary amines, or aliphatic derivatives of heterocyclic secondary and tertiary amines in which the aliphatic radical can be straight- or branched chain. One of the aliphatic substituents contains at least 8 carbon atoms, typically from about 8 to about 18 carbon atoms, and at least one contains an anionic water-solubilizing group e.g. carboxy, sulfonate, sulfate. See U.S. Pat. No. 3,929,678 to Laughlin et al., issued Dec. 30, 1975 at column 19, lines 18-35 (herein incorporated by reference) for examples of ampholytic surfactants.

Zwitterionic surfactants are also suitable for use in agglomerates herein. These surfactants can be broadly described as derivatives of secondary and tertiary amines, derivates of heterocyclic secondary and tertiary amines, or derivatives of quaternary ammonium, quarternary phosphonium or tertiary sulfonium compounds. See U.S. Pat. No. 3,929,678 to Laughlin et al., issued Dec. 30, 1975 at columns 19, line 38 through column 22, line 48 (herein incorporated by reference) for examples of zwitterionic surfactants.

Semi-polar nonionic surfactants are a special category of nonionic surfactants which include water-soluble amine oxides containing one alkyl moiety of from about 10 to about 18 carbon atoms and 2 moieties selected from the group consisting af alkyl groups and hydrocyalkyl groups containing form about 1 to about 3 carbon atoms; water-soluble phosphine oxides containing one alkyl moiety of form about 10 to about 18 carbon atoms and 2 moieties selected form the group consisting of alkyl groups and hydroxyalkyl groups containing from about 1 to about 3 carbon atoms.

Semi-polar nonionic detergent surfactants include the amine oxide surfactants having the formula:

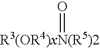

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is form 0 to about 3; and each R⁵ is an alkyl or hydroxyalkyl group containing form about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

The amine oxide surfactants in particular include C₁₀-C₁₈ alkyl dimenthyl amine oxides and C₈-C₁₂ alkoxy ethyl dihydroxy ethyl amine oxides.

The surfactant described above needs to be agglomerated with a carrier which is a powder. The viscous surfactant system is contacted with a finely divided powder carrier which causes the powder to stick together (i.e. agglomerate). The result is a granular composition which generally has a particle size distribution in the range of 250 to 1200 micrometers and has a bulk density of at least 650 g/l. Suitable mixers for carrying out the agglomerates are well known to the man skilled in the art. Any suitable carrier may be chosen as one of the ingredients listed below which may be conveniently handled in powder form, or mixtures thereof. Suitable materials include zeolite, bentonite clay, carbonate, silica, silicate, sulphate, phosphate, citrate and citric acid.

The agglomerate of the present invention further requires the use of a water-soluble salt of acetate. A variety of such salts of acetate are commercially available and can be used in the present invention, including sodium acetate, ammonium acetate, calcium acetate, potassium acetate, rubidium acetate, and magnesium acetate. Mixtures of different salts can also be used. It is undesirable that the acetate should introduce any water into the agglomerate, and so a preferred form of the acetate salt is the anhydrous form. Anhydrous sodium acetate is commercially available from Verdugt.

Acetate also has the advantage that it is available in different granulometries. For the pursposes of the present invention, and to ensure that acetate is in the closest possible proximity with the surfactant, it is desirable to use a very fine powder of acetate, preferably a powder with an average particles size of less than 150 microns, preferably less than 100 microns, more preferably less than 50 microns.

A particular problem encountered with the use of acetate, especially in its anhydrous form is that it is a hygroscopic material which therefore has a strong tendency to cake, even when packed in moisture protected packages. The problem is particularly acute with fine materials which are preferred for use herein. It has now been found that the tendency of the acetate to cake can be eliminated or reduced when the acetate is mixed with aluminosilicates, also referred to as zeolites, particularly overdried zeolites. The result is a powdery mixture of a water-soluble salt of acetate salt and zeolite, suitable for the manufacture of the agglomerate of the present invention. The powdery mixture has improved flowing properties, without significant negatives on the dissolution profile of acetate. The powdery mixture can comprise from 1% to 30% by weight of the mixture of zeolite, and the remainder acetate. Generally, an amount of 1% to 10% zeolite is sufficient to achieve the desired result. Both materials can be mixed together with any suitable equipment, and it is preferred to mix both ingredients at temperature ranging from 10 to 50, preferably from 15 to 30. Indeed, the use of such lower temperature prevents or reduces moisture pick up.

Suitable zeolites for use herein are zeolites. Crystalline aluminosilicate ion exchange material of the formula

Na_{z}[(AlO₂)_{z}.(SiO₂)_{y}].xH₂O

wherein z and y are at least about 6, the molar ratio of z to y is from about 1.0 to about 0.4 and z is from about 10 to about 264. Amorphous hydrated aluminosilicate materials useful herein have the empirical formula

M_{z}(zAlO₂.ySiO₂)

wherein M is sodium, potassium, ammonium or substituted ammonium, z is from about 0.5 to about 2 and y is 1, said material having a magnesium ion exchange capacity of at least about 50 milligram equivalents of CaCO₃ hardness per gram of anhydrous aluminosilicate.

The crystalline aluminosilicate ion exchange materials are further characterized by a particle size diameter of from about 0.1 micron to about 10 microns. Amorphous materials are often smaller, e.g., down to less than about 0.01 micron. Preferred ion exchange materials have a particle size diameter of from about 0.2 micron to about 4 microns. The term “particle size diameter” herein represents the average particle size diameter by weight of a given ion exchange material as determined by conventional analytical techniques such as, for example, microscopic determination utilizing a scanning electron microscope. The crystalline aluminosilicate ion exchange materials herein are usually further characterized by their calcium ion exchange capacity, which is at least about 200 mg equivalent of CaCO₃ water hardness/g of aluminosilicate, calculated on an anhydrous basis, and which generally is in the range of from about 300 mg eq./g to about 352 mg eq./g. The aluminosilicate ion exchange materials herein are still further characterized by their calcium ion exchange rate which is at least about 2 grains Ca⁺⁺/gallon/minute/gram/gallon of aluminosilicate (anhydrous basis), and generally lies within the range of from about 2 grains/gallon/minute/gram/gallon to about 6 grains/gallon/minute/gram/gallon, based on calcium ion hardness. Optimum aluminosilicate for builder purposes exhibit a calcium ion exchange rate of at least about 4 grains/gallon/minute/gram/gallon.

The amorphous aluminosilicate ion exchange materials usually have a Mg⁺⁺ exchange of at least about 50 mg eq. CaCO₃/g (12 mg Mg⁺⁺/g) and a Mg⁺⁺ exchange rate of at least about 1 grain/gallon/minute/gram/gallon. Amorphous materials do not exhibit an observable diffraction pattern when examined by Cu radiation (1.54 Angstrom Units).

Aluminosilicate ion exchange materials useful in the practice of this invention are commercially available. The aluminosilicates useful in this invention can be crystalline or amorphous in structure and can be naturally occurring aluminosilicates or synthetically derived.

A method for producing aluminosilicate ion exchange materials is discussed in U.S. Pat. No. 3,985,669, Krummel et al., issued Oct. 12, 1976, incorporated herein by reference. Preferred synthetic crystalline aluminosilicate ion exchange materials useful herein are available under the designations Zeolite A, Zeolite B, and Zeolite X. In an especially preferred embodiment, the crystalline aluminosilicate ion exchange material has the formula

Na₁₂[(AlO₂)₁₂(SiO2)₁₂].xH₂O

wherein x is from about 20 to about 30, especially about 27 and has a particle size generally less than about 5 microns.

The agglomerates herein can comprise a variety of optional ingredients. A particularly preferred optional ingredient is a water-soluble cationic compound. The water-soluble cationic compounds of the present invention useful in detergent compositions include ethoxylated cationic monoamines, ethoxylated cationic diamines and ethoxylated cationic polyamines as defined hereinafter.

Suitable water-soluble cationic compounds include compounds selected from the group consisting of:

(1) ethoxylated cationic monoamines having the formula:

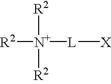

(2) ethoxylated cationic diamines having the formula:

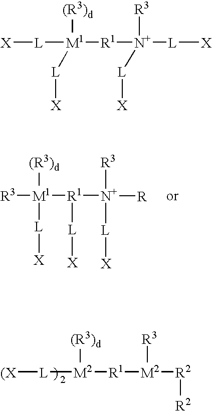

wherein M¹ an N+ or N group; each M² is an N+ or N group, and at least one M² is an N⁺ group;

(3) ethoxylated cationic polyamines having the formula:

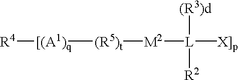

(4) ethoxylated cationic polymers which comprise a polymer backbone, at least 2 M groups and at least one L—X group, wherein M Is a cationic group attached to or integral with the backbone and contains an N+ positively charged center; and L connects groups M and X or connects group X to the polymer backbone; and

(5) mixtures thereof;

wherein

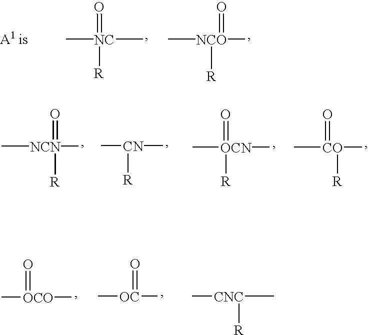

or —O—, R is H or C₁-C₄ alkyl or hydroxyalkyl, R¹ is C₂-C₁₂ alkylene, hydroxyalkykene, alkenylene, arylene or alkarylene, or a C₂-C₃ oxyalkylene moiety having from 2 to about 20 oxyalkylene units provided that no O—N bonds are formed; each R² is C₁-C₄ alkyl or hydroxyalkyl, the moiety —L—X or two R² together form the moiety (CH₂)ᵣ—A² —(CH₂)s-, wherein A² is —O— or —CH₂—, r is 1 or 2, 5 is 1 or 2 and r+s is 3 or 4; each R³ is C₁-C₈ alkyl or hydroxyalkyl, benzyl, the moiety L—X, or two R³ or one R² and one R³ together form the moiety —(CH₂)ᵣ—A²—(CH₂)s-; R⁴ is a substituted C₃-C₁₂ alkyl, hydroxyalkyl, alkenyl, aryl or alkaryl group having p substitution sites; R⁵ is C₁-C₁₂ alkylene, hydroxyalkylene, alkenylene, arylene or alkarylene, or a C₂-C₃ oxyalkylene moiety having from 2 to about 20 oxyalkylene units provided that no O—O or O—N bonds are formed; X is a nonionic group selected from the group consisting of H, C₁-C₄ alkyl or hydroxyalkyl ester or ether groups, and mixtures thereof; L is a hydrophilic chain which contains the polyoxyalkylene moiety —[(R⁶O)m(CH₂CH₂O)n)˜; wherein R⁶ is C₃-C₄ alkylene or hydroxyalkylene and m and n are numbers such that the moiety —(CH₂CH₂O)n- comprises at least about 50% by weight of said polyoxyalkylene moiety; d is 1 when M2 is N+ and is 0 when M2 is N; n is at least about 12 for said cationic monoamines, is at least about 6 for said cationic diamines and is at least about 3 for said cationic polyamines and cationic polymers; p is from 3 to 8; q is 1 or 0; t is 1 or 0, provided that t is 1 when q is 1.

In the preceding formulas for the cationic amines, R¹ can be branched (e.g.

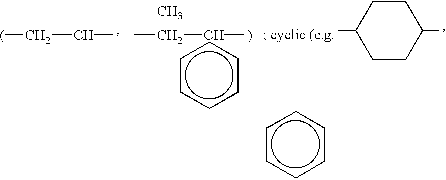

or most preferably linear (e.g. —CH₂CH₂—, —CH₂—CH₂—CH₂—, —CH₂CH)

alkylene, hydroxyalkylene, alkenylene, alkarylene or oxyalkylene. R¹ is preferably C₂-C₆ alkylene for the ethoxylated cationic diamines. Each R₂ is preferably methyl or the moiety —L—X; each R³ is preferably C₁-C₄ alkyl or hydroxyalkyl, and most preferably methyl.

The positive charge of the N⁺ groups is offset by the appropriate number of counter anions. Suitable counter anions include Cl⁻, Br⁻, SO₃⁻², SO₄⁻², PO₄⁻², MeOSO₃⁻ and the like. Particularly preferred counter anions are Cl⁻ and Br⁻.

X can be a nonionic group selected from hydrogen (H), C₁-C₄ alkyl or hydroxyalkyl ester or ether groups, or mixtures thereof. Preferred esters or ethers are the acetate ester and methyl ether, respectively, The particularly preferred nonionic groups are H and the methyl ether.

In the preceding formulas, hydrophilic chain L usually consists entirely of the polyoxyalkylene moiety —[R⁶O)ₘ(CH₂CH₂—Oₙ)—]. The moieties

—(R⁶O)ₘ— and —(CH₂CH₂O)ₙ— of the polyoxyalkylene moiety can be mixed together or preferably form blocks of —(R⁶O)ₘ— and —(CH₂CH₂O)ₙ— moieties. R⁶ is preferably C₃H₆ (propylene); m is preferably from 0 to about 5 and is most preferably 0, i.e. the polyoxyalkylene moiety consists entirely of the moiety —(CH₂CH₂O)ₙ—. The moiety —(CH₂CH₂O)ₙ—.preferably comprises at least about 85% by weight of the polyoxyalkylene moiety and most preferably 100% by weight (m is 0).

In the preceding formulas, M¹ and each M² are preferably an N⁺ group for the cationic diamines and polyamines.

Preferred ethoxylated cationic monoamines and diamines have the formula:

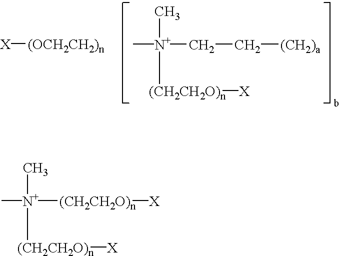

wherein X and n are defined as before, a is from 0 to 4 (e.g. ethylene, propylene, hexamethylene) b is 1 or 0. For preferred cationic monoamines (b=0), n is preferably at least about 12, with a typical range of from about 15 to about 35. For preferred cationic diamines (b=1), n is at least about 12 with a typical range of from about 12 to about 42.

In the preceding formula for the ethoxylated cationic polyamines, R⁴ (linear, branched, or cyclic) is preferably a substituted C₃-C₆ alkyl, hydroxyalkyl or aryl group;

A¹ is preferably

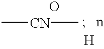

is preferably at least about 12, with a typical

range of from about 12 to about 42; p is preferably from 3 to 6. When R⁴ is a substituted aryl or alkaryl group, q is preferably 1 and R⁵ is preferably C₂-C₃ alkylene. When R⁴ is a substituted alkyl, hydroxyalkyl, or alkenyl group, and when q is 0, R⁵ is preferably a C₂-C₃ oxyalkylene moiety; when q is 1, R⁵ is preferably C₂-C₃.alkylene.

These ethoxylated cationic polyamines can be derived from polyamino amides such as

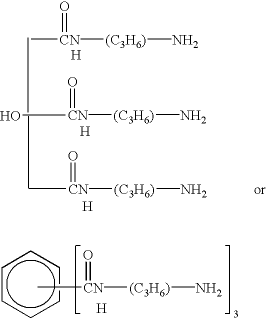

These ethoxylated cationic polyamines can also be derived from polyaminopropyleneoxide derivatives such as

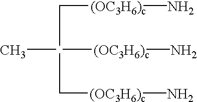

wherein each c is a number from 2 to about 20.

### Methods for Making Cationic Amines

A. Method I

Cationic amines of the present invention can be prepared according to the following scheme:

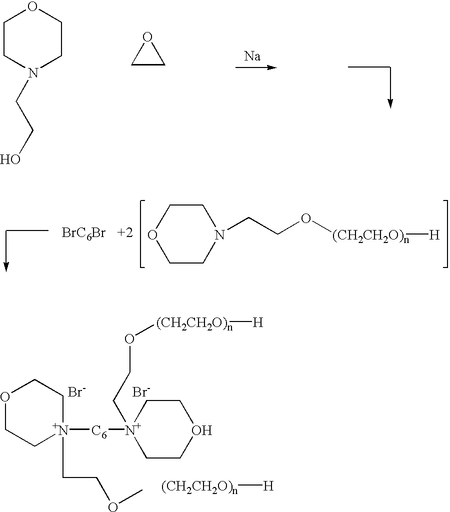

The synthesis of one such cationic amine is described as follows:

### EXAMPLE 1

Step 1: Ethoxylation

N-2-hydroxyethylmorpholine (0.8 moles) is placed in a flask equipped with mechanical stirrer, condenser, argon inlet, ethylene oxide sparger, and internal thermometer. After purging with argon, NaH (0.2 moles) is added to the flask. The reaction mixture is stirred until the NaH has reacted. Ethylene oxide is then added with vigorous stirring while maintaining the temperature at about 80°-120° C. The reaction is stopped when the ethoxylated compound has a degree of ethoxylation of about 11.

Step 2: Quaternization

The ethoxylated compound (0.03 moles) from step 1 is mixed with 1,6-dibromohexane (0.015 moles). The reaction mixture is mixed, sealed in ajar, and heated to 80° C. for ten days to provide crude quaternized 1,6-bis [(-N-morpholiniopolyethoxylate (11)]-hexane dibromide.

B. Method 2

The ethoxylated cationic amines of the present invention can also be prepared by standard methods for ethoxylating and quaternizing amines. There is preferably an initial step of condensing sufficient ethylene oxide to provide 2-hydroxyethyl groups at each reactive site (hydroxyethylation). This initial step can be omitted by starting with a 2-hydroxyethyl amine. The appropriate amount of ethylene oxide is then condensed with these 2-hydroxyethylamines using an alkali metal (e.g., sodium, potassium), or a hydride or hydroxide thereof, as the catalyst to provide the respective ethoxylated amines. The total degree of ethoxylation per reactive site (n) can be determined according to the following formula:

Degree of Ethoxylation=E/(A×R)

wherein E is the total number of moles of ethylene oxide condensed (including hydroxyethylation), A is the number of moles of the starting amine, and R is the number of reactive sites (typically 3 for the mono-amines, 4 for the diamines, and 2×p for polyamines) for the starting amine. The ethoxylated amine can then be quaternized with an alkyl halide such as methyl bromide to form the ethoxylated cationic amine.

Representative syntheses of ethoxylated cationic amines of the present invention by this method are as follows:

### EXAMPLE 2a

Step 1: Ethoxylation

1,6-hexamethylenediamine (100 g., 0.86 moles) was placed in a flask and heated under argon to 85° C. Ethylene oxide (EO) was bubbled into the flask. The reaction temperature was gradually raised to 120° C. over a time period of about 7.5 hours and then raised briefly to 158° C. and cooled back to 100° C. ¹H-NMR indicated that about 4 moles of EO had been incorporated at this point.

Sodium spheres (1.24 g., 0.05 moles) were added and the reaction was stirred overnight after which the sodium had been consumed. The addition of EO was resumed and the reaction temperature raised to 120° C. After about 3 hours, ¹H-NMR indicated that about 10 moles of EO had been incorporated per mole of the diamine. An additional portion of sodium spheres (3.6 g., 0.15 moles) was added and ethoxylation was continued. The temperature was allowed to raise to 125°-130° C. Ethoxylation was continued for about 22 hours. The reaction was terminated when about 96 moles of EO had been taken up per mole of the diamine to give a total degree of ethoxylation of about 24.

Step 2: Quaternization

A portion of the ethoxylated diamine (25 g., 0.0057 moles) from step 1 was quaternized by first dissolving the diamine in methanol (100 ml.) containing a little NaOH. An excess of methyl bromide was added using a dry ice condenser. The reaction mixture was allowed to stand overnight after which the pH had dropped to about 4. NaOH in methanol was added to raise the pH to about 9. The quaternized compound was isolated by stripping off the methanol and remaining methyl bromide. The resulting moist material was washed with several portions of dichloromethane. The combined dichloromethane washes were filtered to remove solids and stripped to yield 27.5 g. of a yellow oil that solidified at room temperature. This oil contained the ethoxylated quaternized diamine.

### EXAMPLE 2b

Step 1: Ethoxylation

Dried triethanolamine (TEA) (16.01 g., 0.107 moles) was catalyzed with 0.5 g. (0.0125 moles) 60% NaH in mineral oil. Ethylene oxide (EO) was then added under atmospheric pressure with stirring at 150°-170° C. After 23 hrs. 36.86 g. (8.38 moles) of EO had been added to give a calculated total degree of ethoxylation of 26.1. The ethoxylated TEA (PEI 17) was a light brown waxy solid.

Step 2: Quaternization

A portion of the ethoxylated TEA (31.68 g., 0.0088 moles) from step 1 was dissolved in H₂O to give about a 50% solution. The solution was heated 60°-70° C. while being stirred magnetically. Methyl bromide gas was swept through the reactor for 8 hrs., with sodium bicarbonate being added as needed to maintain the pH at 7 or greater. After quaternization, the solution was dialized for 3 hrs. to remove the salts. Then the solution was diluted to give 10% aqueous slightly cloudy gold colored solution containing the ethoxylated, quaternized TEA.

### Cationic Polymers

The water-soluble cationic polymers of the present invention comprise a polymer backbone, at least 2 M groups and at least one L—X group, wherein M is a cationic group attached to or integral with the backbone; X is a nonionic group selected from the group consisting of H, C₁-C₄ alkyl or hydroxyalkyl ester or ether groups, and mixtures thereof; and L is a hydrophilic chain connecting groups M and X or connecting X to the polymer backbone.

As used herein, the term “polymer backbone” refers to the polymeric moiety to which groups M and L—X are attached to or integral with. Included within this term are oligomer

is allowed to react with phenylacetylene or the appropriate substituted

As used herein, the term “attached to” means that the group is pendent from the polymer backbone, examples of which are represented by the following general structures A and B:

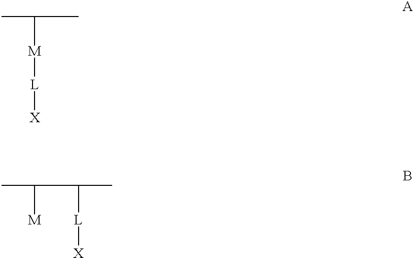

As used herein, the term “integral with” means that the group forms part of the polymer backbone, examples of which are represented by the following structures C and D:

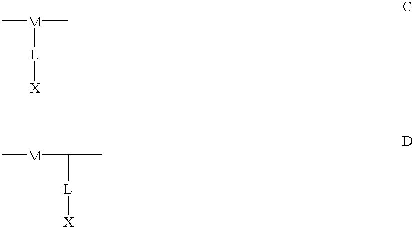

Any polymer backbone can be used as long as the cationic polymer formed is water-soluble and has clay soil removal/anti-redeposition properties. Suitable polymer backbones can be derived from the polyurethanes, the polyesters, the polyethers, the polyamides, the polyimides and the like, the polyacrylates, the polyacrylamides, the polyvinylethers, the polyethylenes, the polypropylenes and like polyalkylenes, the polystyrenes and like polyalkarylenes, the polyalkyleneamines, the polyalkyleneimines, the polyvinylamines, the polyallylamines, the polydiallylamines, the polyvinylpyridines, the polyaminotriazoles, polyvinyl alcohol, the aminopolyureylenes, and mixtures thereof.

M can be any compatible cationic group which comprises an N⁺ (quaternary), positively charged center. The quaternary positively charged center can be represented by the following general structures E and F:

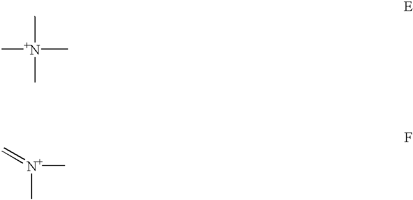

Particularly preferred M groups are those containing a quaternary center represented by general structure E. The cationic group is preferably positioned close to or integral with the polymer backbone.

The positive charge of the N⁺ centers is offset by the appropriate number of counter anions. Suitable counter anions include Cl⁻, Br⁻, SO₃⁻², SO₄⁻², PO₄⁻², MeOSO₃⁻ and the like. Particularly preferred counter anions and Cl⁻ and Br⁻.

X can be a nonionic group selected from hydrogen (H), C₁-C₄ alkyl or hydroxyalkyl ester or ether groups, and mixtures thereof. The preferred ester or ether groups are the acetate ester and methyl ether, respectively. The particularly preferred nonionic groups are H and the methyl ether.

The cationic polymers of the present invention normally have a ratio of cationic groups M to nonionic groups X of from about 1:1 to about 1:2. However, for example, by appropriate copolymerization of cationic, nonionic (i.e. containing the group L—X), and mixed cationic/nonionic monomers, the ratio of cationic groups M to nonionic groups X can be varied. The ratio of groups M to groups X can usually range from about 2:1 to about 1:10. In preferred cationic polymers, the ratio is from about 1:1 to about 1:5. The polymers formed from such copolymerization are typically random, i.e. the cationic, nonionic, and mixed cationic/nonionic monomers copolymerize in a nonrepeating sequence.

The units which contain groups M and groups L—X can comprise 100% of the cationic polymers of the present invention. However, inclusion of other units (preferably nonionic) in the polymers is also permissible. Examples of other units include acrylamides, vinyl ethers, and those containing unquaternized tertiary amine groups (M¹) containing an N center. These other units can comprise from 0 to about 90% of the polymer (from about 10 to 100% of the polymer being units containing M and L—X groups, including M¹-L—X groups). Normally, these other units comprise from 0 to about 50% of the polymer (from about 50 to 100% of the polymer being units containing M and L—X groups).

The number of groups M and L—X each usually ranges from about 2 to about 200. Typically, the number of groups M and L—X are each from about 3 to about 100. Preferably, the number of groups M and L—X are each from about 3 to about 40.

Other than moieties for connecting groups M and X, or for attachment to the polymer backbone, hydrophilic chain L usually consists entirely of the polyoxyalkylene moiety —[(R′O)ₘ(CH₂CH₂O)ₙ]—. The moieties —(R′O)ₘ and (CH₂CH₂O)ₙ— of the polyoxyalkylene moiety can be mixed together, or preferably form blocks of —(R′O)ₘ— and —(CH₂CH₂O)ₙ— moieties. R′ is preferably C₃H₆ (propylene); m is preferably from 0 to about 5, and most preferably 0; i.e. the polyoxyalkylene moiety consists entirely of the moiety —(CH₂CH₂O)ₙ—. The moiety —(CH₂CH₂O)ₙ— preferably comprises at least about 85% by weight of the polyoxyalkylene moiety, and most preferably 100% by weight (m is 0). For the moiety —(CH₂CH₂O)ₙ—, n is usually from about 3 to about 100. Preferably, n is from about 12 to about 42.

A plurality (2 or more) of moieties —L—X can also be hooked together and attached to group M or to the polymer backbone, examples of which are represented by the following general structures G and H:

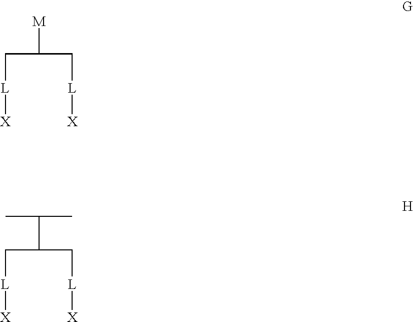

Structures such as G and H can be formed, for example, by reacting glycidol with group M or with the polymer backbone, and ethoxylating the subsequently formed hydroxy groups.

Representative classes of cationic polymers of the present invention are as follows:

A. Polyurethane, Polyester, Polyether, Polyamide or Like Polymers

One class of suitable cationic polymers are derived from polyurethanes, polyesters, polyethers, polyamides and the like. These polymers comprise units selected from those having formulas I, II and III:

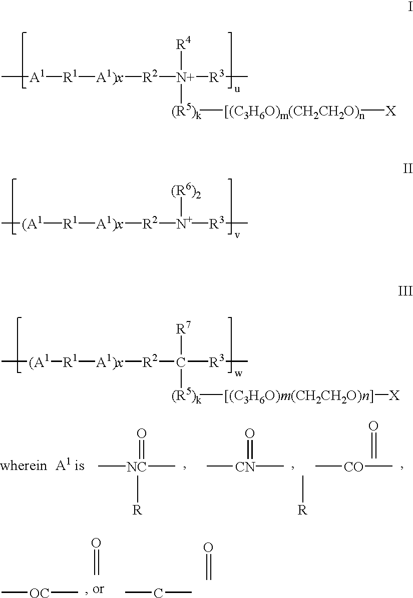

x is 0 or 1; R is H or C₁-C₄ alkyl or hydroxyalkyl; R¹ is C₂-C₁₂ alkylene, hydroxyalkylene, alkenylene, cycloalkylene, arylene or alkarylene, or a C₂-C₃ oxyalkylene moiety having from 2 to about 20 oxyalkylene units provided that no O—O or O—N bonds are formed with A¹ when

x is 1, R² is —R⁵— except when A¹ is

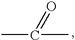

or is —(OR⁸)_{Y}— or —OR⁵— provided that no O—O or N—O bonds are formed with A¹, and R³ is —R⁵— except when A¹ is,

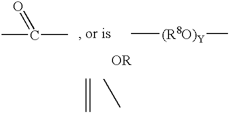

—R⁵O— provided that no O—O or N—O bonds are formed with A¹; when x is 0, R² is 0, R² is —(OR⁸)_{Y}—, —OR⁵—,

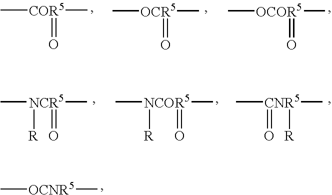

and R³ is —R⁵—; R⁴ is C₁-C₄ alkyl or hydroxyalkyl, or the moiety —(R⁵)ₖ—[(C₃H₆O)ₘ (CH₂CH₂O)ₙ]—X; R⁵ is C₁-C₁₂ alkylene, hydroxyalkylene, alkenylene, arylene, or alkarylene; each R⁶ is C₁-C₄ alkyl or hydroxyalkyl, or the moiety —(CH₂)ᵣ—A²—(CH₂)ₛ—, wherein A² is —O— or —CH₂—; R⁷ is H or R⁴; R⁸ is C₂-C₃

alkylene or hydroxyalkylene; X is H, —CR⁹,

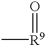

or a mixture thereof, wherein R⁹

is C₁-C₄ alkyl or hydroxyalkyl; k is 0 or 1; m and n are numbers such that the moiety (CH₂ CH₂ O)ₙ— comprises at least about 85% by weight of the moiety —[(C₃H₆O)ₘ(CH₂CH₂ O)ₙ]—; m is from 0 to about 5; n is at least about 3; r is 1 or 2, s is 1 or 2, and r+s is 3 or 4; y is from 2 to about 20; the number of u, v and w are such that there are at least 2 N⁺ centers and at least 2 X groups.

In the above formulas, A¹ is preferably —NC— or

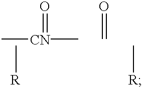

A² is preferably —O—; x is preferably 1; and R is preferably H. R¹ can be linear

(e.g.

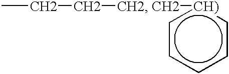

or branched (e.g.

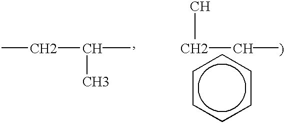

alkylene, hydroxyalkylene, alkenylene, cycloalkylene, alkarylene or oxyalkylene; when R¹ is a C₂-C₃ oxyalkylene moiety, the number of oxyalkylene units is preferably from about 2 to about 12; R¹ is preferably C₂-C₆ alkylene or phenylene, and most preferably C₂-C₆ alkylene (e.g. ethylene, propylene, hexamethylene). R² is preferably —OR⁵— or —(OR⁸)_{y}; R³ is preferably —R⁵O— or —(R⁸O)_{y}—; R⁴ and R⁶ are preferably methyl. Like R¹, R⁵ can be linear or branched, and is preferably C₂-C₃ alkylene; R⁷ is preferably H or C₁-C₃ alkyl; R⁸ is preferably ethylene; R⁹ is preferably methyl; X is preferably H or methyl; k is preferably 0; m is preferably 0; r and s are each preferably 2; y is preferably from 2 to about 12.

In the above formulas, n is preferably at least about 6 when the number of N+ centers and X groups is 2 or 3; n is most preferably at least about 12, with a typical range of from about 12 to about 42 for all ranges of u+v+w. For homopolymers (v and w are 0), u is preferably from about 3 to about 40, and is most preferably from about 3 to about 20. For random copolymers(u is at least 1 or preferably 0), v and w are each preferably from about 3 to about 40).

B. Polyacrylate, Polyacrylamide, Polyvinylether or Like Polymers

Another class of suitable cationic polymers are derived from polyacrylates, polyacrylamides, polyvinylethers and the like. These polymers comprise units selected from those having formulas IV, V and VI:

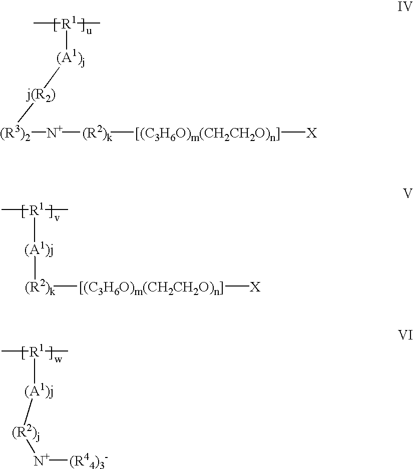

wherein A¹ is —O—,

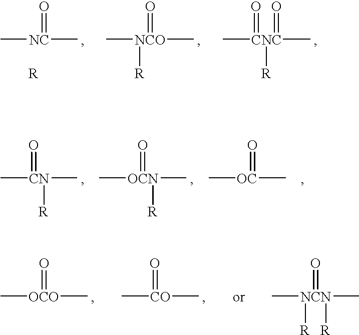

R is H or C₁-C₄ alkyl or hydroxyalkyl; R¹ is substituted C₂-C₁₂ alkylene, hydroxyalkylene, alkenylene, arylene or alkarylene, or C₂-C₃ oxyalkylene; each R² is C₁-C₁₂ alkylene, hydroxyalkylene, alkenylene, arylene or alkarylene; each R³ is C₁-C₄ alkyl or hydroxyalkyl, the moiety —(R²)ₖ—[(C₃H₆O)ₘ(CH₂CH₂O)ₙ]—X, or together form the moiety —(CH₂)ᵣ—A²—(CH₂)ₛ—, wherein A² is —O— or —CH₂—; each R⁴ is C₁-C₄ alkyl or hydroxyalkyl, or two R⁴ together form the moiety —(CH₂)ᵣ—A²—(CH₂)ₛ—; X is H, —CR⁵,

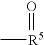

or mixture

thereof, wherein R⁵ is C₁-C₄ alkyl or hydroxyalkyl; j is 1 or 0; k is 1 or 0; m and n are numbers such that the moiety —(CH₂CH₂O)ₙ— comprises at least about 85% by weight of the moiety —[(C₃H₆O)ₘ(CH₂CH₂O)ₙ]—; m is from 0 to about 5; n is at least about 3; r is 1 or 2; s is 1 or 2 and r+s is 3 or 4; the number of u, v and w are such that there are at least 2 N+ centers and at least 2 X groups.

In the above formulas,

A¹ is preferably

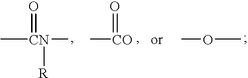

A² is preferably —O—; R is preferably H. R¹

can be linear

(e.g. —CH2-CH—CH2-,

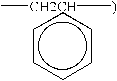

or branched (e.g. —CH2-C—,

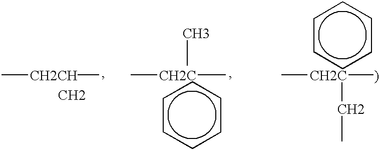

substituted alkylene, hydroxyalkylene, alkenylene, alkarylene or oxyalkylene; R1 is preferably substituted C₂-C₆ alkylene or substituted C₂-C₃ oxyalkylene, and most preferably

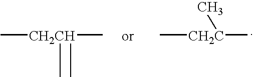

Each R² is preferably C₂-C₃ alkylene; each R³ and R⁴

preferably methyl; R⁵ is preferably methyl; X is preferably H or methyl; j is preferably 1; k is preferably 0; m is preferably 0; r and s are each preferably 2.

In the above formulas, n, u, v, and w can be varied according to the n, u, v and w for the polyurethane and like polymers.

C. Polyalkyleneamine, Polyalkyleneimine or Like Polymers

Another class of suitable cationic polymers are derived from polyalkyleneamines, polyalkyleneimines and the like. These polymers comprise units selected from those having formulas VII and VIII and IX:

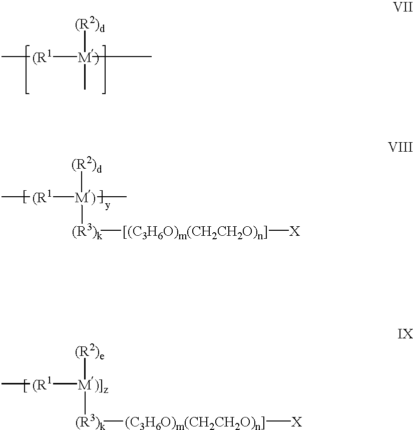

wherein R¹ is C₂-C₁₂ alkylene, hydroxyalkylene, alkenylene, cycloalkylene, arylene or alkarylene, or a C₂-C₃ oxyalkylene moiety having from 2 to about 20 oxyalkylene units provided that no O—N bonds are formed; each R² is C₁-C₄ alkyl or hydroxyalkyl, or the moiety —(R³)ₖ—[(C₃H₆O)ₘ(CH₂CH₂O)ₙ]—X; R³ is

C₁-C₁₂ alkylene, hydroxyalkylene, alkenylene, arylene or alkarylene; M′ is an N+ or N center; X is H,

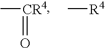

or mixture thereof, wherein R⁴ is C₁-C₄ alkyl

or hydroxyalkyl; d is 1 when M′ is N+ and is 0 when M′ is N; e is 2 when M′ is N+ and is 1 when M′ is N; k is 1 or 0; m and n are numbers such that the moiety —(CH₂CH₂O)ₙ—comprises at least about 85% by weight of the moiety

—[(C₃H₆O)ₘ(CH₂CH₂O)ₙ]—; m is from 0 to about 5; n is at least about 3; the number of x, y and z are such that there are at least 2 M′ groups, at least 2 N+ centers and at least 2 X groups.

In the above formulas, R¹ can be varied like R¹ of the polyurethane and like polymers; each R² is preferably methyl or the moiety —(R³)ₖ—[(C₃H₆O)ₘ (CH₂CH₂O)ₙ]—X; R³ is preferably C₂-C₃ alkylene; R⁴ is preferably methyl; X is preferably H; k is preferably 0; m is preferably 0.

In the above formulas, n is preferably at least 6 when the number of M′ and X groups is 2 or 3; n is most preferably at least about 12, with a typical range of from about 12 to about 42 for all ranges of x+y+z. Typically, x+y+z is from 2 to about 40, and preferably from 2 to about 20. For short chain length polymers, x+y+z can range from 2 to 9 with from 2 to 9 N+ centers and from 2 to 11 X groups. For long chain length polymers, x+y+z is at least 10, with a preferred range of from 10 to about 42. For the short and long chain length polymers, the M′ groups are typically a mixture of from about 50 to 100% N+ centers and from 0 to about 50% N centers.

Preferred cationic polymers within this class are derived from the C₂-C₃ polyalkyleneamines (x+y+z is from 2 to 9) and polyalkyleneimines (x+y+z is at least 10, preferably from 10 to about 42). Particularly preferred cationic polyalkyleneamines and polyalkyleneimines are the cationic polyethyleneamines (PEAs) and polyethyleneimines (PEIs). These preferred cationic polymers comprise units having the general formula:

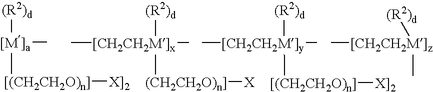

wherein R² (preferably methyl), M′, X, d, x, y, z and n are defined as before; a is 1 or 0.

Prior to ethoxylation, the PEAs used in preparing cationic polymers of the present invention have the following general formula:

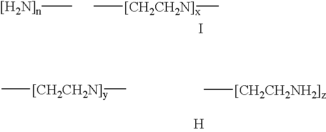

wherein x+y+z is from 2 to 9, and a is 0 or 1 (molecular weight of from about 100 to about 400). Each hydrogen atom attached to each nitrogen atom represents an active site for subsequent ethoxylation. For preferred PEAs, x+y+z is from about 3 to about 7 (molecular weight of from about 140 to about 310). These PEAs can be obtained by reactions involving ammonia and ethylene dichloride, followed by fractional distillation. The common PEAs obtained are triethylenetetramine (TETA) and tetraethylenepentamine (TEPA). Above the pentamines, i.e. the hexamines, heptamines, octamines and possibly nonamines, the cogenerically derived mixture does not appear to separate by distillation and can include other materials such as cyclic amines and particularly piperazines. There can also be present cyclic amines with side chains in which nitrogen atoms appear. See U.S. Pat. No. 2,792,372 to Dickson, issued May 14, 1957, which describes the preparation of PEAs.

The minimum degree of ethoxylation required for preferred clay soil removal/anti-redeposition performance can vary depending upon the number of units in the PEA. Where y+z is 2 or 3, n is preferably at least about 6. Where y+z is from 4 to 9, suitable benefits are achieved when n is at least about 3. For preferred cationic PEAs, n is at least about 12, with a typical range of from about 12 to about 42.

The PEIs used in preparing the polymers of the present invention have a molecular weight of at least about 440 prior to ethoxylation, which represents at least about 10 units. Preferred PEIs used in preparing these polymers have amolecular weight of from about 600 to about 1800. The polymer backbone of these PEIs can be represented by the general formular:

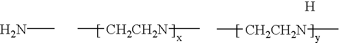

—[—CH₂CH₂NH₂]_{z}

wherein the sum of x, y and z represents a number of sufficient magnitude to yield a polymer having the molecular weights previously specified. Although linear polymer backbones are possible, branch chains can also occur. The relative proportions of primary, secondary and tertiary amine groups present in the polymer can vary, depending on the manner of preparation. The distribution of amine groups is typically as follows:

| | |
|---|---|
| —CH₂CH₂NH₂ | 30% |
| —CH₂CH₂NH— | 40% |
| —CH₂CH₂N— | 30% |

Each hydrogen atom attached to each nitrogen atom of the PEI represents an active site for subsequent ethoxylation. These PEIs can be prepared, for example, for polymerizing ethyleneimine in the presence of a catalyst such as carbon dioxide, sodium bisulfite, sulfuric acid, hydrogen peroxide, hydrochloric acid, acetic acid, etc. Specific methods for preparing PEIs are disclosed in U.S. Pat. No. 2,182,306 to Ulrich et al., issued Dec. 5, 1939; U.S. Pat. No. 3,033,746 to Mayle et al., issued May 8, 1962; U.S. Pat. No. 2,208,095 to Esselmann et al., issued Jul. 16, 1940; U.S. Pat. No. 2,806,839 to Crowther, issued Sep. 17, 1957; and U.S. Pat. No. 2,553,696 to Wilson, issued May 21, 1951 (all herein incorporated by reference).

As defined in the preceding formulas, n is at least about 3 for the cationic PEIs. However, it should be noted that the minimum degree of ethoxylation required for suitable clay soil removal/anti-redeposition performance can increase as the molecular weight of the PEI increases, especially much beyond about 1800. Also, the degree of ethoxylation for preferred polymers increases as the molecular weight of the PEI increases. For PEIs having a molecular weight of at least about 600, n is preferably at least about 12, with a typical range of from about 12 to about 42. For PEIs having a molecular weight of at least 1800, n is preferably at least about 24, with a typical range of from about 24 to about 42.

D. Diallylamine Polymers

Another class of suitable cationic polymers are those derived from the diallylamines. These polymers comprise units selected from those having formulas X and XI:

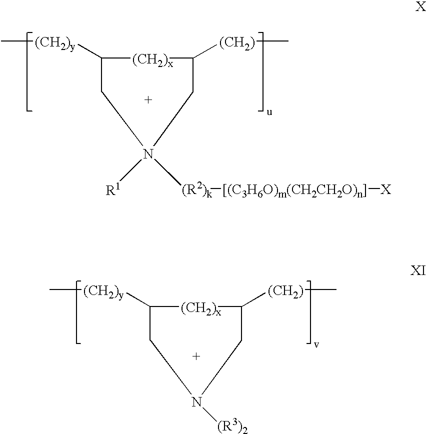

wherein R¹ is C₁-C₄ alkyl or hydroxyalkyl, or the moiety —(R²)ₖ—[(C₃H₆O)ₘ(CH₂CH₂—O)ₙ]—X; R² is C₁-C₁₂ alkylene, hydroxylakylene, alkylene, arylene

or alkarylene; each R³ is C₁-C₄ alkyl or hydroxyalkyl, or together form the moiety —(CH₂)ᵣ—A—(CH₂)ₛ—, wherein A is —O— or —CH₂—; X is H, —CR⁴,

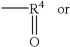

mixture thereof, wherein R⁴ is C₁-C₄ alkyl or hydroxyalkyl; k is 1 or 0; m and n are numbers such that the moiety —(CH₂CH₂O)ₙ— comprises at least about 85% by weight of the moiety [(C₃H₆O)ₘ(CH₂CH₂O)ₙ]—; m is from 0 to about 5; n is at least about 3; r is 1 or 2, s is 1 or 2, and r+s is 3 or 4; x is 1 or 0; y is 1 when x is 0 and 0 when x is 1; the number of u and v are such that there are at least 2 N+ centers and at least 2 X groups.

In the above formulas, A is preferably —O—; R¹ is preferably methyl; each R² is preferably C₂-C₃ alkylene; each R³ is preferably methyl; R⁴ is preferably methyl; X is preferably H; k is preferably 0; m is preferably 0; r and s are each preferably 2.

In the above formulas, n is preferably at least about 6 when the number N+ centers and X groups are each 2 or 3, n is preferably at least 12, with a typical range of from about 12 to about 42 for all ranges of u+v. Typically, v is 0, and u is from 2 to about 40, and preferably from 2 to about 20.

### Methods for Making Cationic Polymers

A. Polyurethane

The polyurethane versions of the present invention can be prepared according to the following general scheme.

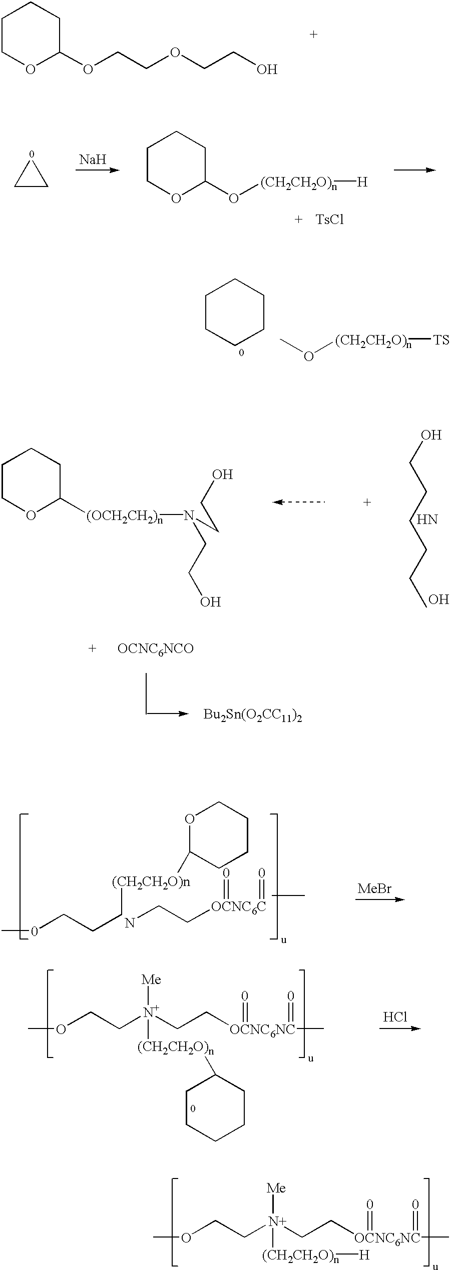

### EXAMPLE 3

Step 1: Ethoxylation

The monotetrahydropyranyl ether of diethylene glycol (1.77 moles) [Compt. Rend., 260, 1399-1401 (1965)] is ethoxylated using 5 mole % NaH to generate a catalytic amount of the corresponding alkoxide. Ethoxylation is conducted at 90°-120° C. until about 22 moles (n=22) of ethylene oxide is taken up for each mole of the starting alcohol to form the ethoxylated compound.

Step 2: Tosylation

The ethoxylated compound from step 1 is dissolved in 1000 ml. of acetonitrile and then cooled to about 10° C. To this solution is added 2.67 moles of tosyl chloride dissolved in 500 ml. of acetonitrile and cooled to 10° C. and then 2.9 moles of triethylamine is added. After the reaction is complete, H₂O is added to decompose the remaining tosyl chloride.

Step 3: Amination

To the reaction mixture from step 3 is added 3.4 moles of diethanolamine. After heating for 18 hrs. at 80° C., the reaction mixture is cooled and carefully acidified with HCl to a pH just above 7 and then extracted with ether. The aqueous phase is then extracted with a mixture of ether:acetonitrile (ratio of about 5:2) twice. The aqueous phase is separated and then made basic with 50% NaOH. This aqueous phase is extracted with dichloromethane (2000 ml.). The lower layer is separated and then extracted 3 times with 2000 ml. portions of ¼ saturated NaCl solution while adding enough 50% NaOH to make the aqueous phase strongly basic (pH of about 11). The lower organic layer is stripped to give the desired aminated compound. Toluene (200 ml.) is added and the mixture stripped again to give the desired aminated monomer.

Step 4: Polymerization

The monomer from step 3 is dissolved in chloroform free of ethanol stabilizer. The monomer is previously evacuated in a Kugelrohr at 80°-90° C. under a vacuum (pressure of 1 mm.) for at least 18 hours. The monomer in the chloroform is then dried overnight with 3 Å molecular sieves and then transferred to a dry flask (equipped with mechanical stirrer) under argon.

To the monomer is added dibutyltin dilaurate catalyst (0.058 mole equiv.) in chloroform under argon. To the stirred reaction mixture is then added 0.7 moles of hexamethylenediisocyanate per mole of aminated monomer over a 5 minute period. The reaction mixture is stirred at room temperature for 18 hours. The chloroform is removed under a vacuum at about 70° C. to give the resulting polymer.

Step 5: Ouaternization and Removal of Protecting Groups

The polymer from step 4 is dissolved in methanol and an excess of methyl bromide is passed in. After about 5 hours, the pH is adjusted to about 4 with aqueous HCl and is then allowed to stand overnight to solvolyze the tetrahydropyranyl protecting group. The solution is then neutralized with NaOH and stripped to give the crude polyurethane. This crude polyurethane is dissolved in chloroform and filtered to remove any salts. The chloroform is stripped away to give the desired, largely salt-free polymer.

B. Random Copolymer of Ethoxylated Acrylate and a Cationic Methacrylamide

The random copolymer versions of the present invention can be prepared according to the following general scheme:

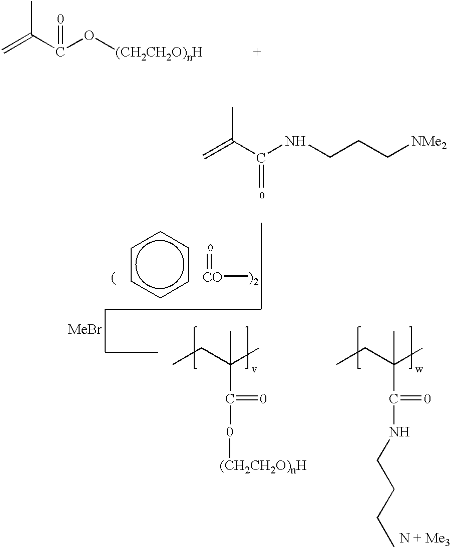

The synthesis of one such random copolymer is descrived as follows:

### EXAMPLE 4

Decaethylene glycol monoethacrylate monomer (0.008 moles) and N-(3-dimethylaminopropyl)-methacrylamide monomer (0.011 moles) are dissolved in 40 ml. of acetonitrile. The reaction mixture is purged of oxygen by bubbling argon through it. A 0.23 g. portion of benzoyl peroxide is separately dissolved in 10 ml. of acetonitrile and similarly purged. The reaction mixture is heated to reflux and the benzoyl peroxide solution then added dropwise over 0.5 hours. Next, 0.28 g. of azobisisobutyronitrile in 5 ml. of acetonitrile is added to the reaction mixture and heating continued overnight. A stream of methyl bromide is then passed through the reaction mixture which is then warmed slightly for 1 hour. The desired random copolymer is isolated by stripping off the solvent.

C. Quaternized Polyethyleneamines and Polyethyleneimines

Quaternized polyethyleneamines and polyethyleneimines can be prepared using standard methods for ethoxylating amines, with subsequent quaternization. Representative syntheses of such polyethyleneamines and polyethyleneimines are as follows:

### EXAMPLE 5a

Step 1: Ethoxylation

Tetraethylenepentamine (TEPA) (M.W. 189, 13.5 g., 0.071 moles) was placed in a nominally dry flask and dried by stirring for 0.5 hrs. at 110°-120° C. under vacuum (pressure less than 1 mm Hg.). The vacuum was released by drawing ethylene oxide (EO) from a prepurged trap connected to a supply tank. Once the flask was filled with EO, an outlet stopcock was carefully opened to a trap connected to an exhaust bubbler. After 3 hrs. stirring at 115°-125° C., ¹H-NMR analysis indicated the degree of ethoxylation of 1 per reactive site. The reaction mixture was cooled while being swept with argon and 0.5 g. (0.0125 moles) of 60% sodium hydride in mineral oil was then added. The stirred reaction mixture was swept with argon until hydrogen evolution ceased. EO was then added to the mixture as a sweep under atmospheric pressure at 117°-135° C. with moderately fast stirring. After 31 hrs., 459 g. (10.43 moles) of EO had been added to give a calculated total degree of ethoxylation of 21.

Step 2: Quaternization

A 34.8 g. (0.0052 moles) portion of the ethoxylated TEPA from step 1 which was a brown waxy solid, was dissolved in D₂O to give a 50% solution. The pH of the solution was about 8. The solution was heated to 60° C. and methyl bromide gas swept through the reaction vessel whose exit was connected to a bubbler. Several times during the reaction, the pH became acidic and NaHCO₃ was added to the reaction to maintain the pH at about 8. After about 20 hrs. a sweep bubbler was placed below the reaction mixture surface so that the methyl bromide was bubbled through the mixture while the stirring rate was increased. After a total of 22 hrs., the reaction mixture was diluted to 25% and dialized to remove salts. The reaction mixture was then freeze dried to give a pale yellowish tan crystalline solid as the quaternized ethoxylated TEPA.

### EXAMPLE 5b

Step 1: Ethoxylation

By a procedure similar to that of Example 3a, PEI (21.5 g., M.W. 600, 0.5 moles) was dried at 120° C. under vacuum and swept with EO until hydroxyethylation was complete (3 hrs.). The hydroxyethylated compound was cooled under argon and 0.1 g. (0.0022 moles) of 50% NaH in mineral oil was added. The reaction mixture was heated to about 70° C. and swept for 13 hrs. with EO until a total of 88.5 g. of EO had been added which gave a calculated degree of ethoxylation of 3.4.

A 53 g. (0.0173 mole) portion of this compound was placed in a similar apparatus, heated to 120° C. and evacuated for 0.5 hrs. then cooled under argon and an additional 0.5 g. (0.010 moles) of 50% NaH was added. EO was swept in for 11 hrs. until 103 g. of EO had been added. This brought the total degree of ethoxylation up to 11.6.

A 74 g. portion (0.0082 moles) of the 11.6 ethoxylated PEI was placed in a similar apparatus and swept with EO for 6 hrs. at 170° C. until 70 g. EO had been added to give a total degree of ethoxylation=23.4.

Step 2: Quaternization

By a procedure similar to that of Example 3a, 20 g. (0.00114 moles) of the 23.4 ethoxylated PEI from step 1 was dissolved in D₂O, heated to 50°-60° C. and swept with methyl bromide for a total of 9 hrs. to provide the quaternized ethoxylated PEI.

D. Diallylamine Polymers

Diallylamine polymer versions of the present invention can be prepared according to the following general scheme:

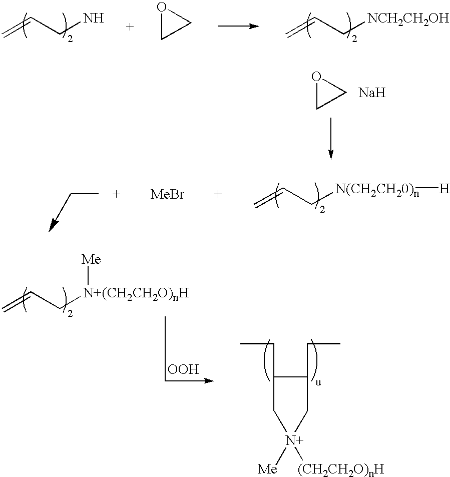

The synthesis of one such polymer is described as follows:

### EXAMPLE 6

Step 1: Ethoxylation

Diallylamine (1.7 moles) is dissolved in methanol (160 ml.) under argon and then heated to 45° C. Ethylene oxide is then added for 2.5 hrs. Methanol is then removed by heating the reaction mixture to 100° C. in vacuo. To the residue is added sodium hydride in mineral oil (6.6 g., 0.165 moles) with stirring until the evolution of hydrogen has ceased. Ethylene oxide is then added until the degree of ethoxylation (n) is about 7.

Step 2: Quaternization

The crude ethoxylated diallylamine from step 1 is dissolved in about an equal volume of IN methanolic NaOH and then methyl bromide is added. This methyl bromide addition is continued until H-NMR analysis shows complete disappearance of the methylene hydrogens adjacent to the tertiary nitrogen. Additional portions of 1 N methanolic NaOH are added as needed to maintain the pH of the reactiom mixture at about 9. The methanol is removed, yielding a damp mass. This damp mass is washed with several portions of dichloromethane. The combined washes are concentrated to yield the desired quaternized compound.

Step 3: Polymerization

The quaternized monomer from step 2 is mixed with D₂O (20 ml.) and heated to 95° C. under argon for 1 hour. Tertbutylhydroperoxide (25 drops) is then added and the reaction continued at 90°C. for 18 hours. Then 20 more drops of the hydroperoxide is added. After heating 3 more days, water is then removed in vacuo (50°-60° C. at pressure of 0.1 mm) to yield the crude polymer.

The cationic compounds for use herein are water-soluble. As used herein, water-soluble preferably means that at least 30 g of compound is soluble in 100 g of water, at 20° C. Indeed, the use of a small amount of a water-soluble cationic compound allows to formulate agglomerates which are much more active, i.e. which comprise a greater amount of surfactant, without any significant impact on the solubility of the agglomerate in water, or without increasing its tendency to gel upon contact with water. It is believed that premixing the compound and the surfactant causes to structure the surfactant paste so as to form a dough of a higher viscosity and reduced stickiness. This, in turn allows for the use of a lesser amount of the carrier, and the overall result is an agglomerate of higher activity.

The agglomerates of the present invention comprise from 10% to 50% by weight of the agglomerate of a surfactant, preferably from 20% to 40%, most preferably from 25% to 35%. The agglomerates of the present invention comprise from 10% to 50% by weight of the agglomerate of a carrier, preferably from 20% to 40%, most preferably from 25% to 35%. The agglomerates of the present invention comprise from 10% to 50% by weight of the agglomerate of acetate, preferably from 20% to 40%, most preferably from 25% to 35%. Finally, the agglomerates of the present invention comprise from 0% to 40% by weight of the agglomerate of water soluble cationic compound, preferably from 2% to 30%, most preferably from 3% to 15%.

A preferred optional ingredient for the surfactant agglomerate is a polymer having a melting point of more than 35° C., preferably of more than 45° C., more preferably of more than 55° C., and most preferably of more than 60° C., including PEGs (poly-ethylene-glycol) for example, most preferred being PEG 4000. Such an ingredient is found particularly useful when the agglomerate comprises a surfactant, more preferably a nonionic surfactant, having a melting temperature of less than 35° C., whereby this surfactant having a melting temperature of less than 35° C. is likely to melt when the agglomerate is placed in high temperature environment, in which case the addition of the polymer having a melting point of more than 35° C. will allow to increase the melting point of the mixture, thus avoiding formation of a liquid phase. This polymer is preferably treated during the process for making the agglomerate at the same time as the surfactant, and is preferably present in proportions of at least 3% and up to 20% by weight of the agglomerate, more preferably in proportions of at least 4 and up to 6%.

Another preferred optional ingredient is a water-soluble salt of citrate so as to further improve the dissolution profile of the agglomerates herein. A variety of such salts of citrate are commercially available and can be used in the present invention. Mixtures of different salts can also be used. It is undesirable that the citrate should introduce any water into the agglomerate, and so a preferred form of the citrate salt is the anhydrous form.

As for the acetate, citrate should be in the closest possible proximity with the surfactant.

A particular problem encountered with the use of citrate, especially in its anhydrous form is that it is a hygroscopic material which therefore has a strong tendency to cake, even when packed in moisture protected packages. The problem is particularly acute with fine materials which are preferred for use herein. It has now been found that the tendency of the citrate to cake can be eliminated or reduced when the citrate is mixed with aluminosilicates, also referred to as zeolites, particularly overdried zeolites. The result is a powdery mixture of a water-soluble salt of citrate salt and zeolite, suitable for the manufacture of the agglomerate of the present invention. The powdery mixture has improved flowing properties, without significant negatives on the dissolution profile of citrate. The powdery mixture can comprise from 1% to 30% by weight of the mixture of zeolite, and the remainder citrate, or acetate, or a mixture of both. Generally, an amount of 1% to 10% zeolite is sufficient to achieve the desired result. These materials can be mixed together with any suitable equipment, and it is preferred to mix these ingredients, i.e. acetate and/or citrate and zeolite at temperature ranging from 10 to 50, preferably from 15 to 30. Indeed, the use of such lower temperature prevents or reduces moisture pick up.

It should be noted that an advantages of the citrate is that it has a function in wash as it acts as a builder. Preferably, the agglomerate comprises a mixture of acetate and citrate instead of acetate alone. The mixture of citrate and acetate may comprise from 1 up to 100% by weight of citrate, and more preferably from 40 up to 60% by weight of citrate.

The process for making the agglomerate

The critical aspect of the process according to the invention is that it must ensure that the acetate is in close proximity with the surfactant in the agglomerate. Such close proximity could not be achieved through dry addition of the acetate with the agglomerate so as to form a final composition. Rather, such close proximity can be achieved by a variety of means which include the two following embodiments.

In a first embodiment, the acetate, or a portion thereof, is intimately mixed with the surfactant before it is agglomerated with the carrier. In a variant of this first embodiment, the acetate is intimately mixed with the carrier before the surfactant is agglomerated with it.

In the second embodiment, the surfactant and the carrier are pre-agglomerated, and the acetate is sprayed onto the pre-agglomerate so as to form the final agglomerate. Both embodiments can be combined in that a portion only of the acetate can be intimately mixed with the surfactant or the carrier. Then, the surfactant and the carrier and the portion of the acetate are pre-agglomerated, and the remainder of the acetate is finally sprayed onto the pre-agglomerate so as to form the final agglomerate.

Optional ingredients in the agglomerate can be formulated in a variety of ways, with the exception of the water-soluble cationic compound which must be mixed with the surfactant before the surfactant is mixed with the carrier. If the acetate is also mixed with the surfactant, it is preferred to first mix the surfactant and the water-soluble cationic compound, then the acetate, then to agglomerate that mix with the carrier.

Other than those particularities, the process herein includes mixing a fluid (the surfactant) with powders (the acetate, the carrier), a fluid (the surfactant) with a fluid (the water-soluble cationic compound), a powder (the acetate) with a powder (the carrier), and those can be performed by any means which are well know to the skilled person. Suitable pieces of equipment to perform those steps include: mixers of the Fukae^{R} FS-G series manufactured by Fukae Powtech Kogyo Co., Japan; this apparatus is essentially in the form of a bowl-shaped vessel accessible via a top port, provided near its base with a stirrer having a substantially vertical axis, and a cutter positioned on a side wall. The stirrer and cutter may be operated independently of one another and at separately variable speeds. The vessel can be fitted with a cooling jacket or, if necessary, a cryogenic unit.

Other similar mixers found to be suitable for use in the process of the invention include Diosna^{R} V series ex Dierks & Söhne, Germany; and the Pharma Matrix^{R} ex T K Fielder Ltd., England. Other mixers believed to be suitable for use in the process of the invention are the Fuji^{R} VG-C series ex Fuji Sangyo Co., Japan; and the Roto^{R} ex Zanchetta & Co srl, Italy.

Other preferred suitable equipment can include Eirich^{R}, series RV, manufactured by Gustau Eirich Hardheim, Germany; Lödige^{R}, series FM for batch mixing, series Baud KM for continuous mixing/agglomeration, manufactured by Lödige Machinenbau GmbH, Paderborn Germany; Drais^{R} T160 series, manufactured by Drais Werke GmbH, Mannheim Germany; and Winkworth^{R} RT 25 series, manufactured by Winkworth Machinery Ltd., Berkshire, England.

The Littleford Mixer, Model #FM-130-D-12, with internal chopping blades and the Cuisinart Food Processor, Model #DCX-Plus, with 7.75 inch (19.7 cm) blades are two examples of suitable mixers. Any other mixer with fine dispersion mixing and granulation capability and having a residence time in the order of 0.1 to 10 minutes can be used. The “turbine-type” impeller mixer, having several blades on an axis of rotation, is preferred. The invention can be practiced as a batch or a continuous process.

In the embodiment herein where the acetate is sprayed onto a pre-agglomerate of the surfactant and the carrier (and optionally the water-soluble cationic compound), it is necessary to first form a solution of the acetate powder so that it becomes a sprayable solution. Suitable sprayable solutions comprise 30 g/l to 60 g/l of acetate, preferably 40 g/l to 50 g/l of acetate. The acetate can be dissolved in a variety of liquid carriers, including water and polyethylene glycol. In that embodiment, any spraying equipment can be used, and it is preferred that the agglomerate is dried after it has been sprayed with the solution of acetate. Again, any conventional drying equipment can be used for this purpose.

Once the surfactant agglomerate has been formed, it can be desirable to subject it to a heating and/or drying step, followed by a cooling step. This will enable the removal of excess moisture.

Also, before the surfactant— or surfactant/water-soluble cationic compound premix—is mixed with the carrier, it is desirable to bring the surfactant—or surfactant/water-soluble cationic compound premix—to a viscosity of about 15000 to 35000 cps, preferably 20000 to 25000 cps. This can be achieved by controlling the temperature of the surfactant or surfactant/water-soluble cationic compound premix. This will enable a more convenient mixing of the surfactant or surfactant/polymer premix with the carrier.

The dissolution profile of the surfactant agglomerate can be measured as follows:

1. A Sotax beaker is filled with 1 liter of de-ionised water and placed in a constant temperature bath set at 10° C. In the beaker, a stirrer with a marine propeller is placed in such a manner that the marine propeller is ± 1 mm below the water surface. The mixer is set at a rotation speed of 200 rpm.

2. 10 g of the surfactant agglomerate to examine is introduced into the Sotax beaker.

3. 30 seconds after the introduction of the surfactant agglomerate, a 2 ml sample of solution is taken by means of a syringe fitted with a filter unit (with a mesh size of 0.45 micron). The filter is used to avoid un-dissolved particles being analyzed and affecting the result.

4. Step 3 is repeated after 1 min, 2.5 min, 5, 10 minutes after the introduction of the agglomerate.

All samples are analyzed for the contents in active material, and compared to the maximum theoretical calculated amount of surfactant in that sample.

The compositions in which the agglomerate can be formulated

While both are usually not distinguished, the agglomerates according to the present invention can be formulated in granular or tablet detergent compositions. Depending on their end use, typically dishwashing or laundry, these detergent compositions can comprise a variety of ingredients including but not limited to other surfactants, builders, chelants, bleaches, bleach activators, soil release polymers, suds controlling or boosting agents, pH adjusting agents, enzymes, enzyme stabilizers, perfumes, brighteners, dye transfer inhibiting agents, and the like.

In the preferred compositions herein, at least 40%, preferably at least 60%, most preferably at least 90% of the surfactant is incorporated by means of the agglomerate.

Granular detergent compositions

In forming a granular detergent composition, the surfactant agglomerates can be simply mixed with the rest of the ingredients that are in particulate form or in turn may be subjected to further process steps of spraying liquids and coating with fine powders.

While the performance of the particles described in the present invention remains excellent, independently of the rest of the product matrix, it can be advantageous to finish the granular detergent composition in a way that maximises performance and permits high flexibility to the formulation of a wide variety of products without major process changes. This can be achieved by taking a modular approach to the building of the finished product matrix.

The modular approach is based on the manufacturing of particles highly specific in one or at most two ingredients of the formulation which are then mixed at the desired ratios to form the finished products. These particles, being highly specific in the ingredient they are to deliver, can be used in a wide range of products without need to be modified. These particles can be prepared with an optimal combination of ingredients that maximize their properties independently of full finished product formulations.

Tablet Detergent Compositions

Detergent tablets can be prepared simply by mixing the solid ingredients together and compressing the mixture in a conventional tablet press as used, for example, in the pharmaceutical industry.

The detergent tablets can be made in any size or shape and can, if desired, be coated.

The particulate materials (other than the agglomerates of the invention) used for making the tablet can be made by any particulation or granulation process. An example of such a process is spray drying (in a co-current or counter current spray drying tower) which typically gives low bulk densities 600 g/l or lower. Particulate materials of higher density can be prepared by granulation and densification in a high shear batch mixer/granulator or by a continuous granulation and densification process (e.g. using Lodige® CB and/or Lodige® KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). A non-gelling binder can be sprayed on to the mix of some, or all of, the particulate materials. Other liquid ingredients may also be sprayed on to the mix of particulate materials either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy®, Korch®, Manesty®, or Bonals®). Tablets prepared should preferably have a diameter of between 40 mm and 60 mm, and a weight between 25 and 100 g. The ratio of height to diameter (or width) of the tablets is preferably greater than 1:3, more preferably greater than 1:2. The compaction pressure used for preparing these tablets need not exceed 5000 kN/m², preferably not exceed 3000 kN/m², and most preferably not exceed 1000 kN/m².

Suitable non-gelling binders include synthetic organic polymers such as polyethylene glycols, polyvinylpyrrolidones, polyacrylates and water-soluble acrylate copolymers. The handbook of Pharmaceutical Excipients second edition, has the following binders classification: Acacia, Alginic Acid, Carbomer, Carboxymethylcellulose sodium, Dextrin, Ethylcellulose, Gelatin, Guar gum, Hydrogenated vegetable oil type I, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferable binders also have an active cleaning function in the laundry wash such as cationic polymers, i.e. ethoxylated hexamethylene diamine quaternary compounds, bishexamethylene triamines, or others such as pentaamines, ethoxylated polyethylene amines, maleic acrylic polymers.

The non-gelling binder materials are preferably sprayed on and hence have an appropriate melting point temperature below 70° C. and preferably below 50° C. so as not to damage or degrade the other active ingredients in the matrix. Most preferred are non-aqueous liquid binders (i.e. not in aqueous solution) which may be sprayed in molten form. However, they may also be solid binders incorporated into the matrix by dry addition but which have binding properties within the tablet.

The non-gelling binder materials are preferably used in an amount within the range from 0.1 to 15% of the composition, more preferably below 5% and especially if it is a non laundry active material below 2% by weight of the tablet.

The tablets may be coated so that the tablet does not absorb moisture, or absorbs moisture at only a very slow rate. The coating is also strong so that moderate mechanical shocks to which the tablets are subjected during handling, packing and shipping result in no more than very low levels of breakage or attrition. Finally the coating is preferably brittle so that the tablet breaks up when subjected to stronger mechanical shock. Furthermore it is advantageous if the coating material is dissolved under alkaline conditions, or is readily emulsified by surfactants. This contributes to avoiding the problem of visible residue in the window of a front-loading washing machine during the wash cycle, and also avoids deposition of undissolved particles or lumps of coating material on the laundry load.

Water solubility is measured following the test protocol of ASTM E1148-87 entitled, “Standard Test Method for Measurements of Aqueous Solubility”.

Suitable coating materials are dicarboxylic acids. Particularly suitable dicarboxylic acids are selected from the group consisting of oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof.

The coating material has a melting point preferably of from 40° C. to 200° C. The coating can be applied in a number of ways. Two preferred coating methods are a) coating with a molten material and b) coating with a solution of the material. In a), the coating material is applied at a temperature above its melting point, and solidifies on the tablet. In b), the coating is applied as a solution, the solvent being dried to leave a coherent coating. The substantially insoluble material can be applied to the tablet by, for example, spraying or dipping. Normally when the molten material is sprayed on to the tablet, it will rapidly solidify to form a coherent coating. When tablets are dipped into the molten material and then removed, the rapid cooling again causes rapid solidification of the coating material. Clearly substantially insoluble materials having a melting point below 40° C. are not sufficiently solid at ambient temperatures and it has been found that materials having a melting point above about 200° C. are not practicable to use. Preferably, the materials melt in the range from 60° C. to 160° C., more preferably from 70° C. to 120° C.

By “melting point” is meant the temperature at which the material when heated slowly in, for example, a capillary tube becomes a clear liquid.

A coating of any desired thickness can be applied according to the present invention. For most purposes, the coating forms from 1% to 10%, preferably from 1.5% to 5%, of the tablet weight.

Such tablet coatings are very hard and provide extra strength to the tablet.

In a preferred embodiment the fracture of the coating in the wash is improved by adding a disintegrant in the coating. This disintegrant will swell once in contact with water and break the coating in small pieces. This will improve the dissolution of the coating in the wash solution. The disintegrant is suspended in the coating melt at a level of up to 30%, preferably between 5% and 20%, most preferably between 5 and 10% by weight. Possible disintegrants are described in Handbook of Pharmaceutical Excipients (1986). Examples of suitable disintegrants include starch: natural, modified or pregelatinized starch, sodium starch gluconate; gum: agar gum, guar gum, locust bean gum, karaya gum, pectin gum, tragacanth gum; croscarmylose Sodium, crospovidone, cellulose, carboxymethyl cellulose, algenic acid and its salts including sodium alginate, silicone dioxide, clay, polyvinylpyrrolidone, soy polysacharides, ion exchange resins and mixtures thereof.

Depending on the composition of the starting material, and the shape of the tablets, the used compaction force will be adjusted to not affect the strength (Diametral Fracture Stress), and the disintegration time in the washing machine. This process may be used to prepare homogenous or layered tablets of any size or shape.

In another preferred embodiment of the present invention the tablets further comprises an effervescent.

Effervescency as defined herein means the evolution of bubbles of gas from a liquid, as the result of a chemical reaction between a soluble acid source and an alkali metal carbonate, to produce carbon dioxide gas,

i.e. C₆H₈O₇+3NaHCO₃→Na₃C₆H₅O₇+3CO₂↑+3H₂O

Tablets can also be used in a method of washing which comprises the preparation of an aqueous solution of a laundry detergent for use in a front-loading washing machine, the front-loading washing machine having a dispensing drawer and a washing drum, wherein the aqueous solution of laundry detergent is formed by the tablet which is placed in the dispensing drawer before water is passed through the dispensing drawer so that the tablet is dispensed as an aqueous solution of a laundry detergent, the aqueous solution subsequently being passed in the washing drum.

In a preferred embodiment, the surfactant agglomerate comprises an anionic surfactant together with an acetate in combination with any other structurant, whereby these components are brought in close proximity by use of a process producing a high shear force such as extrusion. Indeed, it has been found that such a surfactant agglomerate has a high activity, while having satisfactory processability, such satisfactory processability being provided by hardness and low stickiness of the paste obtained. The structurant used may for example be zeolite, silicate, or a mixture of these. It should be noted that satisfactory processability is obtained with surprisingly low levels of acetate, preferably anhydrous sodium acetate, preferably less than 10% per weight of the agglomerate. The agglomerate also preferably comprises more than 40% per weight of anionic surfactant, more preferably more than 50% per weight.

The present invention is illustrated by the following examples.

### EXAMPLES

### Example A

The surfactant particle of composition given in table 1 was prepared as follows:

1. A high shear mixer/agglomerator,(Lodige FM 130) was loaded with a mix comprising anhydrous acetate powder (with a mean particle size below 100 μm) and finely divided sodium carbonate (with a mean particle size below 200 μm).

2. Ethoxylated nonionic surfactant (C14-C15 EO7) was then added to the carbonate/acetate dry mix.

3. The surfactant and the dry powders were agglomerated in the mixer/agglomerator with its plows set at 175 rpm and its chopper set at 3000 rpm until discrete granules were formed.

4. The agglomerates were then transferred to a rotating concrete mixing drum and dusted for 30 sec. with flow aid zeolite.

TABLE 1

| | Composition by weight |
|---|---|
| Anhydrous sodium acetate | 40 |
| Sodium Carbonate | 30 |
| Nonionic surfactant (C45 | 20 |
| AE7) | |
| Flow aid (Zeolite) | 10 |

### Example B

The surfactant particle of composition given in table 2 was prepared as follows:

1. A high shear mixer/agglomerator,(Lodige FM 130) was loaded with a mix comprising 40 parts of anhydrous acetate powder (with a mean particle size below 100 μm) and 20 parts of finely divided sodium carbonate (with a mean particle size below 200 μm).

2. A premix which comprised 26 parts of ethoxylated nonionic surfactant (C14-C15 EO7) and 6 parts of cationic polymer Lutensit KHD96 from BASF (an ethoxylated hexamethylene diamine quat) was then added to the carbonate/acetate dry mix.

3. The surfactant-polymer premix and the dry powders were agglomerated in the mixer/agglomerator with its plows set at 175 rpm and its chopper set at 3000 rpm until discrete granules were formed.

4. The agglomerates were then transferred to a rotating concrete mixing drum and dusted for 30 sec. with 8 parts of flow aid zeolite.

TABLE 2

| | Composition by weight |
|---|---|
| Anhydrous sodium acetate | 40 |
| Sodium Carbonate | 20 |
| Nonionic surfactant (C45 | 26 |
| AE7) | |
| Lutensit KHD96 | 6 |
| Flow aid (Zeolite) | 8 |

### Example C

The process used in example A was repeated using composition given in table 3. In this example, the anhydrous acetate powder of example A was replaced by a premix of anhydrous acetate powder and overdried zeolite in a ratio of 9 parts anhydrous acetate powder for 1 part of overdried zeolite.

TABLE 3

| | Composition by weight |
|---|---|
| Anhydrous sodium acetate/zeolite premix | 40 |
| Sodium Carbonate | 20 |
| Nonionic surfactant (C45 AE7) | 26 |
| Lutensit KHD96 | 6 |
| Flow aid (Zeolite) | 8 |

### Example D-E

The process of example C was repeated replacing anhydrous sodium acetate with anhydrous magnesium acetate or sodium acetate trihydrate powder. The magnesium acetate-zeolite premix here comprised 1 part anhydrous magnesium acetate powder for 9 parts of overdried zeolite.

TABLE 4

| | Example D | Example E |
|---|---|---|
| | weight % | weight % |
| Anhydrous magnesium acetate/ | 40 | |
| zeolite premix | | |
| Sodium acetate trihydrate | | 40 |
| Sodium Carbonate | 20 | 36 |
| Nonionic surfactant (C45 AE7) | 26 | 13 |
| Lutensit KHD96 | 6 | 3 |
| Flow aid (Zeolite) | 8 | 8 |

### Example F-G

The process of example A was repeated replacing surfactant C45 AE7 with various other surfactants as indicated in table 5. Surfactant LAS is Linear alkylbenzene sulphonate, Surfactant AS is a C12-C15 alkyl sulphate.

TABLE 5

| | Example F (LAS) | Example G (AS) |
|---|---|---|
| | Composition by | Composition by |
| | weight | weight |
| Anhydrous Sodium acetate | 30 | 30 |
| Sodium Carbonate | 25 | 20 |
| LAS paste | 35 | — |
| AS paste | — | 40 |
| Flow aid (Zeolite) | 10 | 10 |

### Example H

Example A was repeated using a different particle making process. The process allowed to increase the particle activity without the use of a cationic polymer:

1. A high shear mixer/agglomerator,(EIRICH TYPE RV02) was loaded with a mix comprising anhydrous acetate powder (with a mean particle size below 100 μm) and finely divided sodium carbonate (with a mean particle size below 200 μm).

2. Ethoxylated nonionic surfactant (C14-C15 EO7) was then added to the carbonate/acetate dry mix.

3. The surfactant and the dry powders were agglomerated in the mixer/agglomerator with its chopper set at 1500 rpm and the bowl rotating at 84 rpm.

4. The mixture was then transferred to a dome extruder (Fuji Puadal type Dg-L1) for extrusion.

5. The extrudates formed were then transferred to a rotating mixing drum and dusted for 30 sec. with flow aid zeolite.

TABLE 6

| | Composition by weight |
|---|---|
| Anhydrous sodium acetate | 40 |
| Sodium Carbonate | 30 |
| Nonionic surfactant (C45 AE7) | 25 |
| Flow aid (Zeolite) | 5 |

### Example I

Relative to the previous examples a different process was used to intimately mix the acetate with the surfactant.

1. A high shear mixer/agglomerator,(Lodige FM 130 was loaded with a mix comprising zeolite and finely divided sodium carbonate (with a mean particle size below 200 μm).

2. Surfactant LAS was then added to the carbonate/acetate dry mix.

3. The surfactant and the dry powders were pre-agglomerated in the mixer/agglomerator with its plows set at 175 rpm and its chopper set at 3000 rpm until microgranules were formed in the mixer/agglomerator.

4. A 50 weight % aqueous solution of sodium acetate was sprayed onto the microgranules during agglomeration. The Lodige was set to rotate at 170 rpm and the chopper at 3000 rpm until agglomerates were formed.

5. The agglomerates were then dried in a fluid bed drier set at 80 C for 20 minutes.

The agglomerate after-drying had the composition indicated in table 7

TABLE 7

| | Composition by weight |
|---|---|
| Sodium Carbonate | 30 |
| Zeolite | 25 |
| LAS powder | 20 |
| Sodium acetate 50% solution | 10 |
| Water | 4 |
| Flow aid (Zeolite) | 11 |

### Example J

A detergent base powder of a finished laundry detergent was put together by blending the following components as shown in table 8, except the polyethylene Glycol and perfume which was sprayed-on.

TABLE 8

| | Example J |
|---|---|
| Component | (wt %) |
| Nonionic surfactant agglomerate of example B | 9.9 |
| Anionic surfactant agglomerate | 28.1 |
| Layered silicate compacted granule | 9.0 |
| Granular carbonate | 13.4 |
| Granular percarbonate | 14.2 |
| Anhydrous citric acid | 7.0 |
| Suds suppressor agglomerate | 1.9 |
| Soap powder | 1.4 |
| Granular soil release polymer | 4.5 |
| Bleach activator agglomerate | 5.5 |
| Miscellaneous | 1.1 |
| Enzymes | 2.2 |
| Sodium sulphate | — |
| Polyethylene Glycol spray-on | 1.3 |
| Perfume spray-on | 0.5 |

Anionic agglomerates comprise 38% anionic surfactant, 22% zeolite and 40% carbonate Bleach activator agglomerates comprise 81% TAED (Tetraacethylethylene diamine), 17% acrylic/maleic copolymer (acid form) and 2% water. Zinc phthalocyanine sulphonate encapsulates are 10% active. Suds suppressor agglomerate comprises 11.5% silicone oil (ex. Dow Corning) and 88.5 starch. Layered silicate compacted granule comprises 78% SKS-6, ex Hoechst, 22% citric acid.

The same finished laundry detergent was put together replacing the nonionic surfactant agglomerate by sodium sulphate as a filler as shown in table 8.

### Example K

1. 80 parts of base powder of composition J was mixed in a mixing drum with 11 parts of citric acid anhydrous and 11 parts of sodium carbonate.

2. Tablets were then made the following way, 55 g of the mixture was introduced into a mould of circular shape with a diameter of 5.5 cm and compressed to give tablets of 2 cm height. The tensile strength (or diametrical fracture stress) of the tablet was 9 kPa

### Example L

After the making of tablets of example K, the tablet were dipped in a bath comprising 90 parts of dodecandioic acid mixed with 10 parts of Nymcel zsb 16 heated at 140 C. The time the tablet was dipped in the heated bath was adjusted to allow application of 5 g of the described mixture on it. The tablet was then left to cool at room temperature of 25 C for 24 hours.

### Example M:

i) A detergent base powder of composition M was prepared as follows: all the particulate materials of base composition M were mixed together in a mixing drum to form a homogenous particulate mixture. During this mixing the spray-ons were carried out. After the spray-on the sodium di isoalkylbenzene sulphonate (DIBS) was added to the rest of the matrix.

ii) Tablets were then made the following way. 43 g of the mixture was introduced into a mould of circular shape with a diameter of 5.5 cm and compressed to give a tablet tensile strength (or diametrical fracture stress) of 15 kPa.

| | Composition M |
|---|---|
| | (%) |
| Anionic agglomerates 1 | 9.1 |
| Anionic agglomerates 2 | 22.5 |
| Nonionic agglomerates | 9.1 |
| Cationic agglomerates | 4.6 |
| Layered silicate | 9.7 |
| Sodium percarbonate | 12.2 |
| Bleach activator agglomerates | 6.1 |
| Sodium carbonate | 7.27 |
| EDDS/Sulphate particle | 0.5 |
| Tetrasodium salt of Hydroxyethane Diphosphonic | 0.6 |
| acid | |
| Soil Release Polymer | 0.3 |
| Fluorescer | 0.2 |
| Zinc Phthalocyanine sulphonate encapsulate | 0.03 |
| Soap powder | 1.2 |
| Suds suppressor | 2.8 |
| Citric acid | 5.5 |
| Protease | 1 |
| Lipase | 0.35 |
| Cellulase | 0.2 |
| Amylase | 1.1 |
| Binder spray-on system | 3.05 |
| Perfume spray-on | 0.5 |
| DIBS | 2.1 |

Anionic agglomerates 1 comprise of 40% anionic surfactant, 27% zeolite and 33% carbonate Anionic agglomerates 2 comprise of 40% anionic surfactant, 28% zeolite and 32% carbonate Nonionic agglomerate comprise 26% nonionic surfactant, 6% Lutensit K-HD 96, 40% Sodium acetate anhydrous, 20% carbonate and 8% zeolite. Cationic agglomerates comprise of 20% cationic surfactant, 56% zeolite and 24% sulphate Layered silicate comprises of 95% SKS 6 and 5% silicate Bleach activator agglomerates comprise of 81% TAED, 17% acrylic/maleic copolymer (acid form) and 2% water.

Ethylene diamine N,N-disuccinic acid sodium salt/Sulphate particle comprise of 58% of Ethylene diamine N,N-disuccinic acid sodium salt, 23% of sulphate and 19% water. Zinc phthalocyanine sulphonate encapsulates are 10% active. Suds suppressor comprises of 11.5% silicone oil (ex Dow Corning); 59% of zeolite and 29.5% of water. Binder spray-on system comprises of 0.5 parts of Lutensit K-HD 96 and 2.5 parts of PEGs

What is claimed is:

1. A surfactant agglomerate comprising a surfactant and a carrier, characterized in that it further comprises a water-soluble salt of acetate in close proximity with the surfactant.

2. An agglomerate according to claim 1, wherein the surfactant is a nonionic surfactant.

3. An agglomerate according to claim 1, whereby it further comprises a polymer having a melting point of more than 35° C.

4. An agglomerate according to claim 2, wherein the nonionic surfactant is an ethoxylated alcohol.

5. An agglomerate according to any of claim 4 which further comprises a water-soluble cationic compound.

6. An agglomerate according to claim 1 which comprises from 15% to 55% by weight of the agglomerate of surfactant, from 10% to 40% by weight of the agglomerate of carrier, and from 10% to 40% of the acetate, and from 0% to 20% by weight of the agglomerate of water-soluble cationic compound.

7. An agglomerate according to claim 6 which comprises from 25% to 35% by weight of the agglomerate of surfactant, from 25% to 35% by weight of the agglomerate of carrier, from 25% to 35% of the acetate, and from 0% to 15% by weight of agglomerate of water-soluble cationic compound.

8. A process for making an agglomerate according to claim 1 wherein the acetate, or a portion thereof, is mixed with the surfactant or the carrier before the surfactant is agglomerated with the carrier.

9. A process for making an agglomerate according claim 7 wherein the acetate, or a portion thereof is sprayed onto a pre-agglomerate of the surfactant and the carrier and, optionally the other portion of the acetate.

10. A process according to claim 9 where the water-soluble cationic compound is mixed with the surfactant before the surfactant is mixed with the carrier.

11. A granular detergent composition which comprises an agglomerate according to claim 7 and other detergency ingredients.

12. A tablet detergent composition which comprises an agglomerate according to claim 7 and other detergency ingredients.

13. A composition according to claim 12 wherein at least 40%, of the surfactant is incorporated in the composition by means of the agglomerate.

14. A powdery mixture of a water-soluble salt of acetate salt and zeolite, suitable for the manufacture of an agglomerate according to claim 7.

15. A composition according to claim 13 wherein at least 60% of the surfactant is incorporated in the composition by means of the agglomerate.

16. A composition according to claim 15 wherein at least 90% of the surfactant is incorporated in the composition by means of the agglomerate.
